(19) United States
(12) Patent Application Publication
(10) Pub. No.: US 2025/0040511 A1
(43) Pub. Date: Feb. 6, 2025

(54) KIND OF CAGE FOR ANIMALS

(71) Applicant: Weijie Xu, Zhejiang (CN)

(72) Inventor: Weijie Xu, Zhejiang (CN)

(21) Appl. No.: 18/364,991

(22) Filed: Aug. 3, 2023

(51) Int. Cl. A01K 1/03

(52) U.S. Cl. CPC A01K 1/03

(57) ABSTRACT

A cage including frame and first connecting member that assembles a plurality of the frame into the cage, characterized in that. in some embodiments, the frame may include a plurality of connection rod, protective plate, fixing bar supporting and fixing the protective plate to the connection rod and second connector. in some embodiments, the connection rod has a plurality of track groove, the protective plate may be fixed to the track groove, and the second connector may be fixed to a plurality of the connection rod in connection. in some embodiments, the first connecting member may include a first step, a second step, a recess, and a threaded hole post. in some embodiments, the second step in the upper portion of the first step, the threaded hole post extends through the first step and the second step, and the recess disposed between the first step and the second step.

### TECHNICAL FIELD

The present invention relates to the technical field of a cage, in particular A kind of cage for animals.

### BACKGROUND

With the improvement of the quality of life in society, the market for pets and their related articles has gradually developed and grown in recent years, and the demand for pet cages is also growing, however, most of the cages on the market can only be used individually, and it is not possible to realize a plurality of cages stacked on top of each other or extended from side to side, and it is not possible to combine a plurality of cages into a single cage to satisfy the customer's requirements for the use of cages with large dimensions, and only single cages can be arranged in simple rows or stacked, and it is not possible to form an integral whole, therefore, a cage that can be extended and stacked to solve the above mentioned raised problems.

In the U.S. patent for Invention U.S. Pat. No. 7,059,274B2 discloses a combination pet cage, wherein the frames of the cage are provided with threaded holes, which allow the mesh panels to be assembled into a cage by means of threaded connections. A plurality of insertion holes is also provided on the top and bottom surfaces of the frames of the front mesh panels and the rear mesh panels, and two such combined pet cages can be connected vertically by means of connectors. A plurality of pet cages is connected in the same manner. However, the plurality of ways of connecting such cages tends to make the cages sway and the overall structure is not stable.

### SUMMARY

Embodiments of the present disclosure may include a cage including frame and first connecting member that assembles a plurality of the frame into the cage, characterized in that. in some embodiments, the frame may include a plurality of connection rod, protective plate, fixing bar supporting and fixing the protective plate to the connection rod and second connector. in some embodiments, the connection rod has a plurality of track groove, the protective plate may be fixed to the track groove, and the second connector may be fixed to a plurality of the connection rod in connection.

In some embodiments, the first connecting member may include a first step, a second step, a recess, and a threaded hole post. in some embodiments, the second step may be in the upper portion of the first step, the threaded hole post extends through the first step and the second step, and the recess may be disposed between the first step and the second step, embodiments may also include wherein, when a plurality of the frame may be to be stacked and extended, the second connector may be connected and fixed to a plurality of the connection rod, the second connector may be interspersed in the first connecting member, and the first connecting member connects a plurality of different the frame to form a removable stacking and extension of the frame.

Embodiments may also include a cage according to, characterized in that the connection rod may be internally provided with a threaded rod, embodiments may also include a cage according to, characterized in that the second connector has a plurality of outwardly extending square on its surface, embodiments may also include a cage according to, characterized in that one of the surfaces of the second connector may be provided with through-hole, the through-hole running through the square.

Embodiments may also include a cage according to, characterized in that the second connector may be provided with a projection on its surface, embodiments may also include a cage according to, characterized in that the second connector may be provided with concave block on the surface of the second connector, and the concave block may be connected to the through-hole, embodiments may also include a cage according to, characterized in that the protective plate may be provided with ventilation hole, facilitating the circulation of air within the cage.

Embodiments may also include a cage according to, characterized in that the front part of the protective plate may be a movable plate, the material of which may be transparent and visible, and can be an acrylic plate, glass, or organic plate, embodiments may also include a cage according to, characterized in that the movable plate may be provided with a handle. in some embodiments, the customer can better observe and take care of the pet in the cage.

Embodiments may also include a cage according to, characterized in that the protective plate may include a bottom plate and a top plate. in some embodiments, the fixing bar supports and reinforces the bottom of the bottom plate plat and the top plate, embodiments may also include a cage according to, characterized in that the fixing bar locks connection rod by means of a snap hook, and further, the locking method may also be a threaded connection or a key connection.

Embodiments may also include a cage according to, characterized in that the protective plate may be provided with knob on the back, embodiments may also include a cage according to, characterized in that the threaded hole post and the threaded rod may be connected and fixed by means of threads, preferably, the connection may also be a snap connection or a key connection, embodiments may also include a cage according to, characterized in that when a plurality of the frame may be connected, support bar may be provided therein, and the support bar may be used to hang items such as lamps, embodiments may also include a cage according to, characterized in that the material of the connection rod and the fixing bar may be an aluminum profile, preferably, the material may also be a hard metal product such as alloy steel.

Embodiments of the present disclosure may also include a cage connecting member including a frame and a first connecting member for assembling a plurality of the frame into the cage, characterized in that, said frame including a plurality of connection rod, protective plate, fixing bar supporting and fixing the protective plate to the connection rod and second connector. in some embodiments, the connection rod has a plurality of track groove with the protective plate being fixed to the track groove. the second connector may be fixed in connection with the plurality of the connection rod.

In some embodiments, the first connecting member including a first step, a second step, a recess, and a threaded hole post. in some embodiments, the second step may be located in the upper portion of the first step, the second step being smaller in area than the first step, the first step being provided with two adjacent sides of the first step surface with stopper, the stopper being in the shape of an L, the recess being provided between the second step and the stopper, the threaded hole post being provided in the middle of the second step, running through the first step and the second step, the threaded hole post extending out of the first connecting member to form a column, the threaded hole post may be provided with a round block at an extended portion of the threaded hole post, the threaded hole post may be connected to the round block, and the first connecting member may be provided with a square groove at the bottom of the first connecting member, embodiments may also include wherein, when a plurality of the frame need to be stacked and extended, the second connector may be connected and fixed with a plurality of the connection rod, the second connector may be inserted in the first connecting member, and the first connecting member connects a plurality of different the frame, thereby forming the frame of removably stacked and extended.

Embodiments may also include a cage connecting member according to, characterized in that the first connecting member of may be a plastic element, in some embodiments the material may be an alloy, stainless steel or copper, embodiments may also include a cage connecting member according to, characterized in that the first connecting member may be connected to the second connector by means of a piercing, preferably, the connection may be by means of a snap connection, embodiments may also include a cage connecting member according to, characterized in that the extension of the threaded hole post may be a cylindrical body, furthermore, the extension may also be a square dwelling.

Embodiments of the present disclosure may also include a cage connection method including frame, first connecting member and support bar for assembling a plurality of the frame into the cage, characterized in that. in some embodiments, the frame including a plurality of connection rod, protective plate, fixing bar supporting the fixing of the protective plate to the connection rod and second connector. in some embodiments, the connection rod has a plurality of track groove with the protective plate being fixed to the track groove. the second connector may be fixed in connection with the plurality of the connection rod.

In some embodiments, the first connecting member including a first step, a second step, a recess, and a threaded hole post. in some embodiments, the second step may be located in the upper portion of the first step, the second step being smaller in area than the first step, the first step being provided with two adjacent sides of the first step surface with stopper, the stopper being in the shape of an 1, the recess being provided between the second step and the stopper, the threaded hole post being provided in the middle of the second step, running through the first step and the second step, the threaded hole post extending out of the first connecting member to form a column, the threaded hole post may be provided with a round block at an extended portion of the threaded hole post, the threaded hole post may be connected to the round block, and the first connecting member may be provided with a square groove at the bottom of the first connecting member, embodiments may also include when the frame needs to be connected in more than one combination, the threaded hole post may be fixed to the bottom of the second connector, the round block may be fixedly cooperated with the concave block, and the threaded hole post may be fixedly cooperated with the through-hole to prevent the first connecting member from generating relative rotation, the projection fixed in the square groove, the threaded hole post fixed with the threaded rod by threaded connection.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a block diagram illustrating a cage, according to some embodiments of the present disclosure.

FIG. 2 is a block diagram further illustrating the cage from FIG. 1, according to some embodiments of the present disclosure.

FIG. 3 is a block diagram illustrating a cage connecting member, according to some embodiments of the present disclosure.

### DISCLOSURE DESCRIPTION OF EMBODIMENTS

In the following, the technical scheme in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

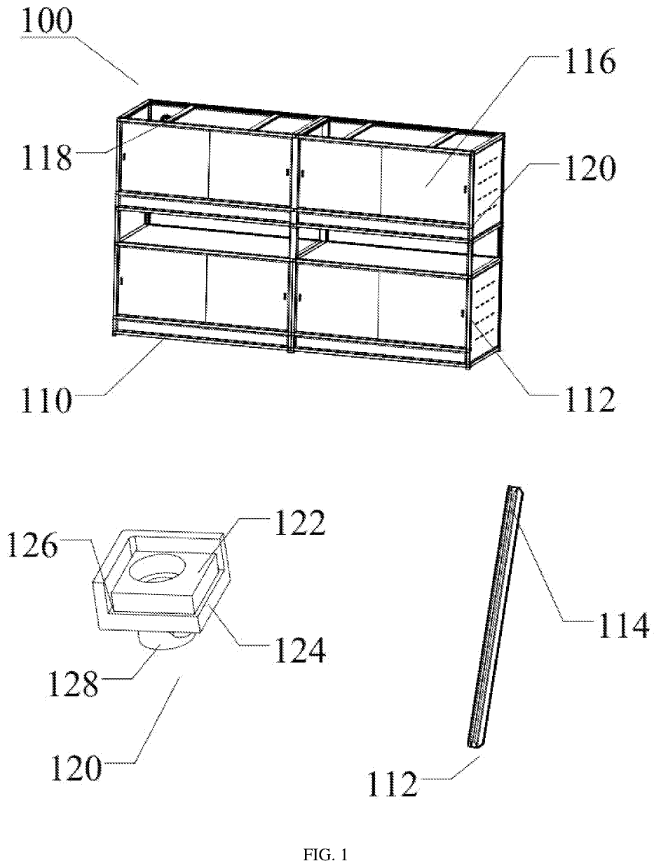

FIG. 1 is a block diagram that describes a cage 100, according to some embodiments of the present disclosure. in some embodiments, the cage 100 may include frame 110. the cage 100 may also include first connecting member 120 that assembles a plurality of the frame 110 into the cage 100, characterized in that. the frame 110 may include a plurality of connection rod 112, protective plate 116, and fixing bar 118 supporting and fixing the protective plate 116 to the connection rod 112 and second connector. the plurality of connection rod 112 may also include a plurality of track groove 114, the protective plate 116 may be fixed to the track groove 114, and the second connector may be fixed to a plurality of the connection rod 112 in connection.

In some embodiments, the first connecting member 120 may include a first step 122, a second step 124, a recess 126, and a threaded hole post 128. when a plurality of the frame 110 may be to be stacked and extended, the second connector may be connected and fixed to a plurality of the connection rod 112, the second connector may be interspersed in the first connecting member 120, and the first connecting member 120 connects a plurality of different the frame 110 to form a removable stacking and extension of the frame 110. the second step 124 may be in the upper portion of the first step 122, the threaded hole post 128 extends through the first step 122 and the second step 124, and the recess 126 may be disposed between the first step 122 and the second step 124.

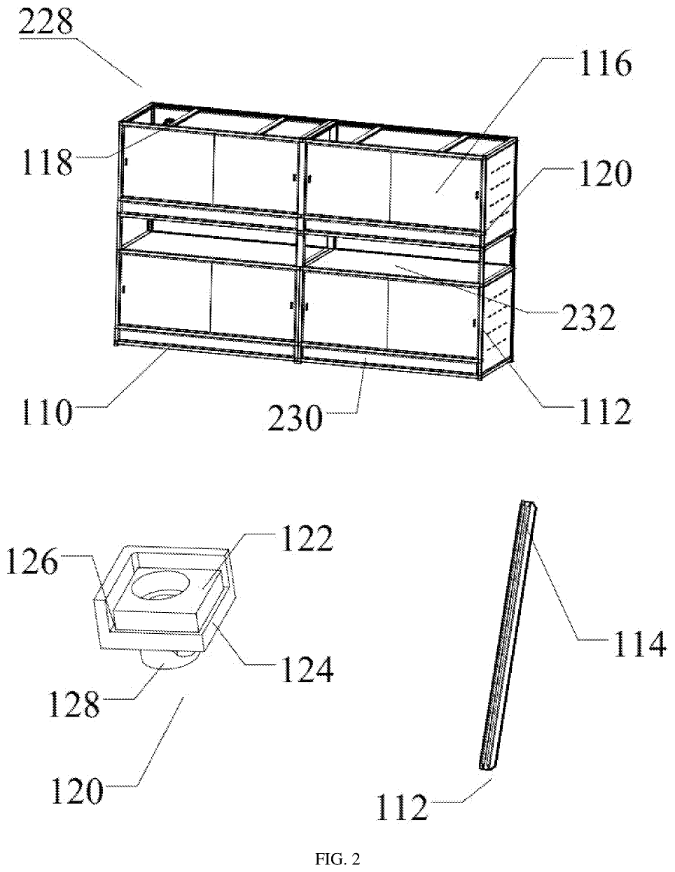

FIG. 2 is a block diagram that further describes the cage 100 from FIG. 1, according to some embodiments of the present disclosure. in some embodiments, characterized in that the connection rod 112 may be internally provided with a threaded rod. in some embodiments, the cage may include a plurality of outwardly extending square on its surface. in some embodiments, characterized in that one of the surfaces of the second connector may be provided with through-hole, the through-hole running through the square. in some embodiments, characterized in that the second connector may be provided with a projection on its surface.

In some embodiments, characterized in that the second connector may be provided with concave block on the surface of the second connector, and the concave block may be connected to the through-hole. in some embodiments, characterized in that the protective plate 116 may be provided with ventilation hole, facilitating the circulation of air within the cage. in some embodiments, characterized in that the front part of the protective plate 116 may be a movable plate, the material of which may be transparent and visible, and can be an acrylic plate, glass or organic plate.

In some embodiments, characterized in that the movable plate may be provided with a handle. the customer can better observe and take care of the pet in the cage. in some embodiments, the cage 228 may include a bottom plate 230 and a top plate 232. the fixing bar 118 may support and reinforces the bottom of the bottom plate plat and the top plate 232. in some embodiments, characterized in that the fixing bar 118 locks connection rod by means of a snap hook, and further, the locking method may also be a threaded connection or a key connection.

In some embodiments, characterized in that the protective plate 116 may be provided with knob on the back. in some embodiments, characterized in that the threaded hole post 128 and the threaded rod may be connected and fixed by means of threads, preferably, the connection may also be a snap connection or a key connection. in some embodiments, characterized in that when a plurality of the frame 110 may be connected, support bar may be provided therein, and the support bar may be used to hang items such as lamps. in some embodiments, characterized in that the material of the connection rod and the fixing bar 118 may be an aluminum profile, preferably, the material may also be a hard metal product such as alloy steel.

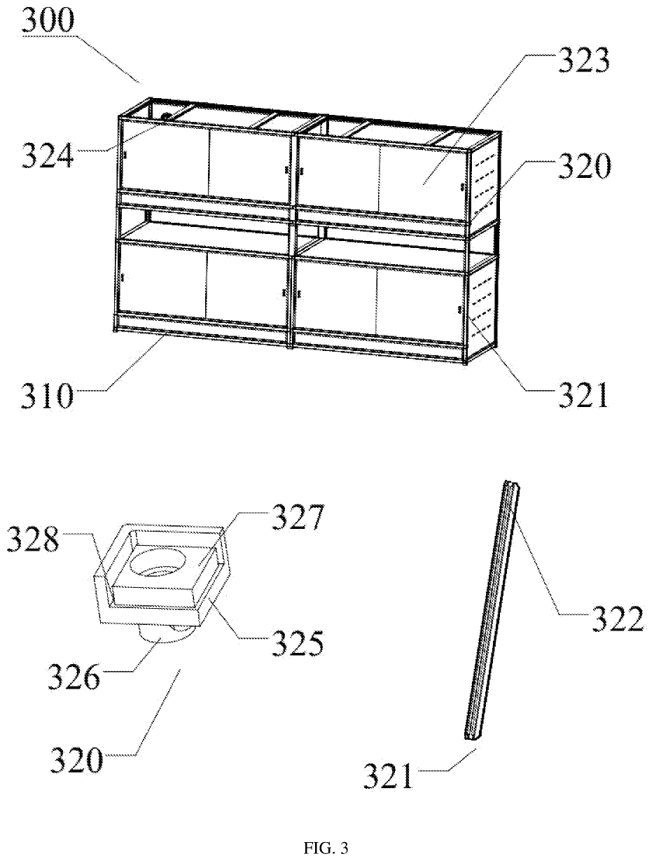

FIG. 3 is a block diagram that describes a cage connecting member 300, according to some embodiments of the present disclosure. in some embodiments, the cage connecting member 300 may include a frame 310. the cage connecting member 300 may also include a first connecting member 320 for assembling a plurality of the frame 310 into the cage, characterized in that, said frame. the first connecting member 320 may include a plurality of connection rod 321, protective plate 323, fixing bar 324 supporting and fixing the protective plate 323 to the connection rod 321 and second connector, a first step 327, a second step 325, a recess 328, and a threaded hole post 326. the plurality of connection rod 321 may include a plurality of track groove 322 with the protective plate 323 being fixed to the track groove 322. the second connector may be fixed in connection with the plurality of the connection rod 321.

In some embodiments, when a plurality of the frame 310 may need to be stacked and extended, the second connector may be connected and fixed with a plurality of the connection rod 321, the second connector may be inserted in the first connecting member 320, and the first connecting member 320 connects a plurality of different the frame 310, thereby forming the frame of removably stacked and extended. the second step 325 may be located in the upper portion of the first step 327, the second step 325 being smaller in area than the first step 327, the first step 327 being provided with two adjacent sides of the first step surface with stopper, the stopper being in the shape of an 1, the recess 328 being provided between the second step 325 and the stopper, the threaded hole post 326 being provided in the middle of the second step 325, running through the first step 327 and the second step 325, the threaded hole post 326 extending out of the first connecting member 320 to form a column, the threaded hole post 326 may be provided with a round block at an extended portion of the threaded hole post 326, the threaded hole post 326 may be connected to the round block, and the first connecting member 320 may be provided with a square groove at the bottom of the first connecting member 320.

In some embodiments, characterized in that the first connecting member 320 of may be a plastic element, in some embodiments the material may be an alloy, stainless steel or copper. in some embodiments, characterized in that the first connecting member 320 may be connected to the second connector by means of a piercing, preferably, the connection may be by means of a snap connection. in some embodiments, characterized in that the extension of the threaded hole post 326 may be a cylindrical body, furthermore, the extension may also be a square dwelling.

In some embodiments, frame, first connecting member and support bar for assembling a plurality of the frame into the cage, characterized in that. the frame comprising a plurality of connection rod, protective plate, fixing bar supporting the fixing of the protective plate to the connection rod and second connector. the connection rod may have a plurality of track groove with the protective plate being fixed to the track groove. the second connector may be fixed in connection with the plurality of the connection rod. the first connecting member comprising a first step, a second step, a recess, and a threaded hole post. the second step may be located in the upper portion of the first step, the second step being smaller in area than the first step, the first step being provided with two adjacent sides of the first step surface with stopper, the stopper being in the shape of an 1, the recess being provided between the second step and the stopper, the threaded hole post being provided in the middle of the second step, running through the first step and the second step, the threaded hole post extending out of the first connecting member to form a column, the threaded hole post may be provided with a round block at an extended portion of the threaded hole post, the threaded hole post may be connected to the round block, and the first connecting member may be provided with a square groove at the bottom of the first connecting member. when the frame may need to be connected in more than one combination, the threaded hole post may be fixed to the bottom of the second connector, the round block may be fixedly cooperated with the concave block, and the threaded hole post may be fixedly cooperated with the through-hole to prevent the first connecting member from generating relative rotation, the projection fixed in the square groove, the threaded hole post fixed with the threaded rod by threaded connection.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A kind of cage for animals comprising frame and first connecting member that assembles a plurality of said frame into said cage, characterized in that,
Said frame comprises a plurality of connection rod, protective plate, fixing bar supporting and fixing said protective plate to said connection rod and second connector, wherein said connection rod have a plurality of track groove, said protective plate are fixed to said track groove, and said second connector is fixed to a plurality of said connection rod in connection;
Said first connecting member comprises a first step, a second step, a recess, and a threaded hole post, wherein said second step is located in the upper portion of said first step, said threaded hole post extends through said first step and said second step, and said recess is disposed between said first step and said second step;
Wherein, when a plurality of said frame are to be stacked and extended, said second connector is connected and fixed to a plurality of said connection rod, said second connector is interspersed in said first connecting member, and said first connecting member connects a plurality of different said frame to form a removable stacking and extension of said frame.

2. A kind of cage for animals according to claim 1, characterized in that said connection rod is internally provided with a threaded rod.

3. A kind of cage for animals according to claim 2, characterized in that said second connector has a plurality of outwardly extending square on its surface.

4. A kind of cage for animals according to claim 3, characterized in that one of the surfaces of said second connector is provided with through-hole, said through-hole running through said square.

5. A kind of cage for animals according to claim 4, characterized in that said second connector is provided with a projection on its surface.

6. A kind of cage for animals according to claim 5, characterized in that said second connector is provided with concave block on the surface of said second connector, and said concave block is connected to said through-hole.

7. A kind of cage for animals according to claim 6, characterized in that said protective plate is provided with ventilation hole, facilitating the circulation of air within the cage.

8. A kind of cage for animals according to claim 7, characterized in that the front part of said protective plate is a movable plate, the material of which is transparent and visible, and can be an acrylic plate, glass or organic plate.

9. A kind of cage for animals according to claim 8, characterized in that said protective plate comprises a bottom plate and a top plate, wherein said fixing bar supports and reinforces the bottom of said bottom plate plat and said top plate.

10. A kind of cage for animals according to claim 9, characterized in that said fixing bar locks connection rod by means of a snap hook, and further, the locking method may also be a threaded connection or a key connection.

11. A kind of cage for animals according to claim 10, characterized in that said threaded hole post and said threaded rod are connected and fixed by means of threads, preferably, the connection may also be a snap connection or a key connection.

12. A kind of cage for animals according to claim 11, characterized in that when a plurality of said frame are connected, support bar may be provided therein, and said support bar may be used to hang items such as lamps.

13. A kind of cage for animals according to claim 12, characterized in that the material of said connection rod and said fixing bar is an aluminum profile, preferably, the material may also be a hard metal product such as alloy steel.

14. A cage connecting member comprising a frame and a first connecting member for assembling a plurality of said frame into said cage, characterized in that,
Said frame comprising a plurality of connection rod, protective plate, fixing bar supporting and fixing said protective plate to said connection rod and second connector, wherein said connection rod have a plurality of track groove with said protective plate being fixed to said track groove. Said second connector is fixed in connection with said plurality of said connection rod;
Said first connecting member comprising a first step, a second step, a recess and a threaded hole post, wherein said second step is located in the upper portion of said first step, said second step being smaller in area than said first step, said first step being provided with two adjacent sides of said first step surface with stopper, said stopper being in the shape of an 1, said recess being provided between said second step and said stopper, said threaded hole post being provided in the middle of said second step, running through said first step and said second step, said threaded hole post extending out of said first connecting member to form a column, said threaded hole post is provided with a round block at an extended portion of said threaded hole post, said threaded hole post is connected to said round block, and said first connecting member is provided with a square groove at the bottom of said first connecting member;
Wherein, when a plurality of said frame need to be stacked and extended, said second connector is connected and fixed with a plurality of said connection rod, said second connector is inserted in said first connecting member, and said first connecting member connects a plurality of different said frame, thereby forming a said frame of removably stacked and extended.

15. A cage connecting member according to claim 14, characterized in that said first connecting member of is a plastic element, in some embodiments the material may be an alloy, stainless steel or copper.

16. A cage connecting member according to claim 15, characterized in that said first connecting member is connected to said second connector by means of a piercing, preferably, the connection may be by means of a snap connection.

17. A cage connecting member according to claim 16, characterized in that the extension of said threaded hole post is a cylindrical body, furthermore, the extension may also be a square dwelling.

18. A cage connection method comprising frame, first connecting member and support bar for assembling a plurality of said frame into said cage, characterized in that,
Said frame comprising a plurality of connection rod, protective plate, fixing bar supporting the fixing of said protective plate to said connection rod and second connector, wherein said connection rod have a plurality of track groove with said protective plate being fixed to said track groove. Said second connector is fixed in connection with said plurality of said connection rod;
Said first connecting member comprising a first step, a second step, a recess and a threaded hole post, wherein said second step is located in the upper portion of said first step, said second step being smaller in area than said first step, said first step being provided with two adjacent sides of said first step surface with stopper, said stopper being in the shape of an 1, said recess being provided between said second step and said stopper, said threaded hole post being provided in the middle of said second step, running through said first step and said second step, said threaded hole post extending out of said first connecting member to form a column, said threaded hole post is provided with a round block at an extended portion of said threaded hole post, said threaded hole post is connected to said round block, and said first connecting member is provided with a square groove at the bottom of said first connecting member;
When said frame needs to be connected in more than one combination, said threaded hole post is fixed to the bottom of said second connector, said round block is fixedly cooperated with said concave block, and said threaded hole post is fixedly cooperated with said through-hole to prevent said first connecting member from generating relative rotation, said projection fixed in said square groove, said threaded hole post fixed with said threaded rod by threaded connection.

19. A method of connecting cages according to claim 18, characterized in that when said frame are vertically stacked, said support bar are provided between different said frame, and said support bar are interspersed in said recess, thereby completing the stacking of said frame.

20. A method of connecting cages according to claim 19, characterized in that when the cages are extended horizontally, said frame to be combined are connected by two connected said first connecting member, said first connecting member being fixed to said second connector at the top and at the bottom in said frame.
